(19) United States
(12) Patent Application Publication
(10) Pub. No.: US 2006/0195636 A1
(43) Pub. Date: Aug. 31, 2006

(54) Large volume data management

(76) Inventors: Xidong Wu, Livermore, CA (US); Baofeng Jiang, Pleasanton, CA (US)

Correspondence Address: MATTHEW E. BURR;LAKE AUSTIN MARINA, 2219 WESTLAKE DR, STE 200, AUSTIN, TX, 78746, US

(21) Appl. No.: 11/068,559

(22) Filed: Feb. 28, 2005

(51) Int. Cl. G06F 13/12

(52) U.S. Cl. 710/68

(57) ABSTRACT

In memory (memory-resident) compression tools are used to manage large volumes of data. Large volume data is transported in a compressed format. In memory compression software reads the data in its compressed format and then uncompresses the data in memory for data processing. After the data is uncompressed and aggregated in the memory, in memory compression software compresses the data into binary blocks [210]. The data is stored in a database as a binary object (BLOB). The in memory binary blocks are inserted directly into the database [220].

### CROSS-REFERENCE TO RELATED APPLICATIONS

The present application claims priority from U.S. patent application Ser. No. 10/288,266, now U.S. Pat. No. 6,795,880, filed Nov. 5, 2002, entitled “SYSTEM AND METHOD FOR PROCESSING HIGH SPEED DATA,” naming inventor Baofeng Jiang, and published U.S. patent application Ser. No. 10/887,146, Pub. No. US 2004/0250001 A1, filed Jul. 8, 2004, entitled “SYSTEM AND METHOD FOR PROCESSING HIGH SPEED DATA,” naming inventor Baofeng Jiang, both of which related documents are incorporated herein by reference in their entirety.

### FIELD OF THE INVENTION

The present invention relates generally to the management of large volume data.

### BACKGROUND OF THE INVENTION

A data storage and management system for large telecom networks typically includes the following procedures:
Data Acquisition: obtain data from networked data servers located in different geographic regions.
Data aggregation: sort, aggregate and transform the acquired data into a form in which it can be accessed efficiently based on the requirements of the enterprise.
Data Storage: load data into a permanent storage location, such as a relational database.

A typical large telecom network has thousands of network elements and millions of circuits located in diverse geographic areas. The data volume is very high. For example, data volume from one provider's ADSL network alone is about 30-40 Giga bytes per collection. Storing and managing such large volumes of data often presents serious performance and storage space issues for the enterprise.

### BRIEF DESCRIPTION OF THE DRAWINGS

The present invention is further described in the detailed description that follows, by reference to the noted drawings, by way of non-limiting examples of embodiments of the present invention, in which reference numerals represent similar features throughout the views of the drawing, and in which:

FIG. 1 is a block diagram schematic of prior art logic.

FIG. 2 is a block diagram schematic of a solution of an exemplary embodiment of the present invention.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with frequent reference to in memory compression applications. It is understood that in memory or memory resident compression software is merely an example of a specific embodiment of the present invention, which is directed broadly to data management, together with attendant networks, systems and methods, within the scope of the invention. The terminology, therefore, is not intended to limit the scope of the invention.

To transport a large volume of data over a network from regional data servers to a central data management server strains the network if the data is not in compressed form (i.e., jar, gzip, zlib, and the like). Traditionally, if the data is indeed in compressed form, the data must be uncompressed to disks for further processing. The process of decompressing to disk and processing the data is very slow because it strains the disk I/O.

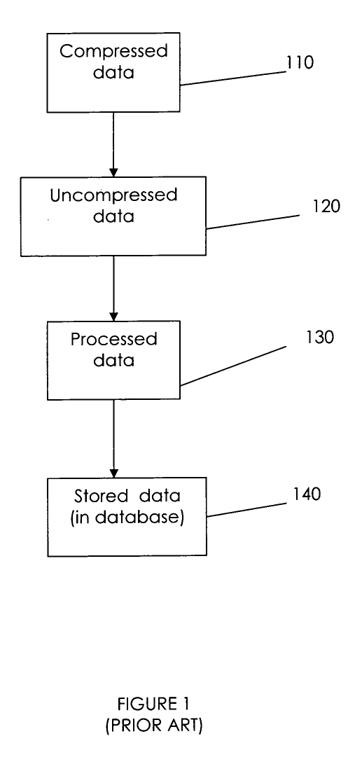

FIG. 1 is a block diagram schematic of prior art logic. Compressed large volume data 110 is uncompressed 120 using a selected decompression application. Uncompressed data 120 is processed 130, again by a suited selected application, and is stored in a database 140.

A large amount of disk space is required to store a large volume of data in a database. To access the data efficiently requires the use of indexing. The size of indexing tables sometimes exceeds that of data tables. Regardless of how the indexing is designed, the efficiency of data access and retrieval inevitably deteriorates as the volume of stored data increases. Of course, the data can be stored in compressed forms, but this also requires compressing the data to hard disks, which similarly strains disk I/O. Saving data in compressed form, therefore, does not solve the I/O problem for large volumes of data.

Thankfully, the present invention solves the problems of I/O speed, and access and retrieval efficiency, for large data volumes with the following approach:
1: Transport the data in compressed format.
2: Use in memory uncompressing. Use in memory (memory-resident) compression software to read the data in its compressed format and then uncompress the data in memory for data processing.
3: Use in memory compressing. After the data is uncompressed and aggregated in the memory, use in memory compression software to compress the data into binary blocks.
4: Store data in database as binary object (BLOB). The in memory binary blocks are inserted into a database directly.

Accordingly, the present invention uses in memory data decompression to save the step of data uncompressing to disk before processing the data. Using In memory data compression saves the step of data compressing to a disk with separate software programs (such as jar or gzip).

The present invention inserts binary blocks to a database directly from memory to minimize disk I/O operations. Direct BLOB insertion also saves disk storage space.

Existing solutions for managing large data volumes are disk I/O intensive. In contrast, the present approach of data processing is CPU intensive. The experience of the present inventors is that the present approaches has proven to be much more efficient than existing disk I/O intensive applications.

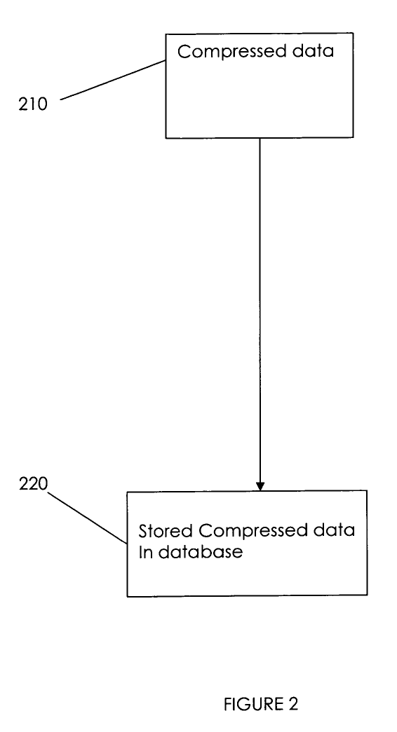

Turning now to FIG. 2, FIG. 2 is a block diagram schematic of a solution of an exemplary embodiment of the present invention. FIG. 2 illustrates the conceptual scheme of the present invention. As is evident upon comparison with FIG. 1, the present invention saves two steps, or two disk reads and two disk writes. Compressed data 210 is transmitted and stored directly into database 220.

The invention makes large volume data management more efficient by dramatically reducing data processing time and disk storage space. For example, to process the aforementioned ADSL performance data and load it into database with the present method, data processing time is only one eighth, and storage space is only one third of prior art solutions.

A further advantage of the present invention is that it makes large volume data lookup more efficient by retrieving data in compressed format and greatly reducing index table size.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

We claim:

1. A method for managing large volumes of data to reduce disk I/O, the method comprising:
obtaining data to be managed;
compressing [210] the processed data in memory to one or more binary block; and
storing [220] one or more binary block directly in a database.

2. The method of claim 1, further comprising:
reading the compressed data in memory;
uncompressing the data in memory; and
processing the uncompressed data.

3. The method of claim 1, further comprising transmitting the data in compressed form.

4. The method of claim 2, wherein reading the compressed data in memory is performed with memory-resident software.

5. The method of claim 2, wherein uncompressing the data in memory is performed with memory-resident software.

6. The method of claim 1, wherein compressing the processed data in memory to one or more binary block is performed with memory-resident software.

7. The method of claim 1, wherein saving one or more binary block directly in a database is performed with memory-resident software.

8. The method of claim 1, wherein one or more binary block further comprises a BLOB.

9. The method of claim 2, wherein the data is not uncompressed to disk before processing.

10. The method of claim 1, wherein the data is not compressed to disk.

11. The method of claim 10, wherein disk storage space is conserved.

12. The method of claim 10, wherein the number disk I/O operations is reduced.

13. The method of claim 1, wherein database storage space is conserved.

14. A database [220] for storing large volumes of data, the database comprising one or more binary block [210] created by memory resident software and inserted from the memory directly into the database.

15. The database of claim 14, wherein at least one binary block comprises a BLOB.

16. The database of claim 14, wherein the database is a relational database.

17. A system for managing large volumes of data to reduce disk I/O, the system comprising:
a quantity of data to manage;
an in memory application to compress the data to one or more binary block [210]; and
a database [220] in which to store one or more of binary block of data inserted directly into the database.

18. The system of claim 17, wherein the database is a relational database.

19. The system of claim 17, wherein the in memory application also reads the compressed data and uncompresses the data for processing prior to compressing the data into one or more binary block.

20. The system of claim 19, further comprising one or more data processing application to process the uncompressed data.
